(19) United States
(12) Patent Application Publication
(10) Pub. No.: US 2005/0257079 A1
(43) Pub. Date: Nov. 17, 2005

(54) System for the creation of a supercomputer using the CPU of the computers connected to internet

(76) Inventor: Andrea Arcangeli, Imola (BO) (IT)

Correspondence Address: YOUNG & THOMPSON, 745 SOUTH 23RD STREET, 2ND FLOOR, ARLINGTON, VA, 22202, US

(21) Appl. No.: 10/832,258

(22) Filed: Apr. 27, 2004

(51) Int. Cl. G06F 11/00

(52) U.S. Cl. 714/4

(57) ABSTRACT

A system permitting the creation of a supercomputer using the connection of the computers to the Internet network and, through it, to a central server, where a program is installed in order to connect possible sellers with possible buyers of CPU of computers, so that sellers can make their offer and buyers can make their demand, both of them specifying price and amount of CPU resources. When demand and offer meet, the system will automatically give access to the purchased seller's CPU to the buyer and it will transfer the agreed sum from the buyer to the seller. The transaction can be cancelled either by both parties or automatically by the system in prefixed conditions.

### TECHNICAL FIELD

The present invention concerns the technical sector relative to the design and realization of systems for the connection of several computers in order to realize a so-called “supercomputer”.

### BACKGROUND ARTICLE

Supercomputers are computers able to provide much higher computing powers than ordinary PCs.

At the current state, supercomputers are normally obtained connecting “standard” CPUs each other, so as to permit a parallelism of calculations occurring at the same time on all the CPUs. If 100 identical computers carry out 1/100 of a complex problem at the same time, it's possible to get the same results in almost 1/100 of the time necessary to reach them with a single computer.

Until 2003, the most powerful supercomputer ever manufactured is the “earth simulator”, characterized by 640 nodes with 8 CPUs each, totally 5120 CPUs. Interconnections among said CPUs are very efficient, especially inside the node. The costs for the production are considerably high, both for installation and maintenance, as well as for the costs of electrical energy, hire and air conditioning equipment.

It's sufficient to know that each node burns 20 kW the most of which are dispersed in heat.

Obviously, few people can hope to own a computer with such a computing capacity.

Selling, purchasing or granting CPU resources has become for a long time a common method to reach such a great computing power without owning a supercomputer. Just think about the supercomputers supplied for rent from companies working in the field of software and/or hardware, or the initiatives with GRID systems that even allow owners of computers connected to Internet to grant their electrical and computing resources to scientists for research purposes.

Rent supercomputers nowadays on the market ensure security and reliability, because they are exclusively based on hardware and software totally administered and guaranteed directly by the “seller”. As a matter of fact, the “seller” manufactures a supercomputer (in a traditional way or with GRID techniques), employing computing resources of his own company or in cooperation with associated companies, in order to rent the resources of such a supercomputer. This fact restricts the computing power of said rent supercomputer to computing resources directly administered by the provider or the group of the various associated companies.

On the other hand, GRID systems, such as seti@home or www.grid.org, are able to reprocess a part of the waste of the word global CPU, allowing idle computers connected to Internet to make part of an allocated supercomputer, but they do not offer any guarantee on the accuracy of the results: they offer neither privacy on the data, nor privacy on the software running on the donors' CPUs, in addition they cause a higher consumption of energy of the processor during the donation of the resources (when the processor is not idle), which implies higher expenditure in electricity.

Therefore, the application field of the current GRID systems, running through the Internet, is restricted to few applications (such as the research against cancer, the research of alien life in the cosmos and other similar scientific applications), as well as the amount of available machines is restricted to the ones voluntary granted, since no compensation is given for the higher energy consumption of the processor when it's not idle.

### DISCLOSURE OF INVENTION

The system object of this invention can solve the reliability and security problems of the GRID systems running on the Internet, such as www.grid.org, avoids the restrictions of the rent supercomputers, and offers additional interesting characteristics that are not known in the other kinds of supercomputers existing today.

This system has several advantages and characteristics. It allows any computer connected to Internet and with an underused CPU to join the WORLD WIDE SUPERCOMPUTER, so as to make its resources theoretically unlimited.

Also computers under firewall or NAT will not find any problem joining the WORLD WIDE SUPERCOMPUTER. It offers profits to the owners of the computers making part of the WORLD WIDE SUPERCOMPUTER, so as to spur hardware's owners to join the system. It offers a more convenient price to the buyers of the resources of the WORLD WIDE SUPERCOMPUTER than the rental costs of the supercomputers; it can also offer a greater purchasing computing power. It ensures reliable results thanks to new cryptographical mode supplied by the hardware, in order to prevent any virus or the same owner of the hardware to alter the computations with any software technique. It's possibly more reliable than current rent supercomputers realized by means of GRID systems inside a controlled environment, which, for example, are theoretically vulnerable to viruses from the seller of the resources. It makes communications anonymous, cryptic and safe, so as to guarantee privacy on the data and the software used for computations and make them impossible to be traced on the Internet or by any software running on the computer where computing is made. It can make the buyers and sellers of the resources completely unidentified, in this way the buyer cannot know on which computer his software runs, the seller on his turn cannot know for which user his hardware works. It allows the buyer to select the parts of the WORLD WIDE SUPERCOMPUTER to purchase, on the basis of technical factors relating to the computer where computation will run, e.g. he can select factors such as the available storage, the processor operations, the band and the latency of connection to the network and also the Internet location of these computers by means of IP range. It's important to note that this selection permits to repeat the same computation in different parts of the world and on different hardware, therefore it's possible to compare the results for a greater accuracy against any possible systematic hardware mistake (like a bitflip in the ram, such a mistake that statistically can also occur on computers perfectly working).

In addition, this system generates a reliable market for the CPU resources and allows sellers and buyers of resources joining the WORLD WIDE SUPERCOMPUTER to autonomously agree the price, like in a normal computerized stock exchange, such as the NASDAQ, in order to offer the best price of the CPU available on the market. It ensures the correct payment to the seller and the reliability of computation resources to the buyer. It can improve the latency of communications and the traffic created on the main Internet backbones by means of a graph that traces the IPs of the connected clients, so that the buyer can select the nearest sellers, thus reducing also the latency periods in the communications. This ability to buy resources from the nearest computers will be very important when many secondary servers, where this system runs, are spread all around the world. At the beginning, there will be only one server placed in a large band point on the Internet, possibly in one of the backbones. The installation of the secondary servers will take place progressively, with the development of the WORLD WIDE SUPERCOMPUTER according to geographical points with more users. These secondary servers will permit a “local” transfer of the software for the computation and of the results, without passing through the main servers that could be even far from the location of the seller and buyer clients. The system generates a profit and it sustains itself by charging a commission on all the computing transactions successfully completed and in turn finished with the payment to the seller for its CPU resources.

The most important and innovative characteristic of this system is the ability to provide dependable results and to make unidentifiable, therefore extremely safe, the communications of the data generated from the computation as well as the software used for the same computations, even if this software runs on remote computers where no controls exist by the buyer and by the system. This is made possible thanks to a cryptographical mode that must be provided by the hardware. An implementation of this necessary hardware function will be shortly introduced in the market by the forthcoming PCs, known as “trusted computing”. Said hardware function has been developed thanks to the cooperation of many hardware and software vendors by means of the Trusted Computing Platform Alliance (www.trustedcomputing.org) and the TCG (www.trustedcomputinggroup.org). The reasons for which it has been developed do not involve this system or the creation of a WORLD WIDE SUPERCOMPUTER.

The solution to design a system using this new hardware technology called “trusted computing”, for the creation of a “trusted” WORLD WIDE SUPERCOMPUTER, is absolutely innovative. Without a cryptographical mode equivalent to the “trusted computing” into the hardware, this system could however work and would be still innovative for all its other functions, but it could lose the guarantees of privacy on the computed data and on the software used for computation and, furthermore, it couldn't provide any reliability on the results. Removing these guarantees, the WORLD WIDE SUPERCOMPUTER would not attract enough buyers, since without these two guarantees the purposes of its applications would be restricted, consequently it couldn't be profitable.

One of the most common applications for which the “trusted computing” has been developed and advertised is, for example, the possibility to launch an anti-virus and ensure that no viruses or other programs could prevent its action and results. Thus, if the anti-virus does not find any virus, it means that viruses actually do not exist. The selling client has exactly the same dependable needs of the anti-virus: as a matter of fact, in order to be sure of the result supplied by the selling client, this client must not be attacked in any way by external software agents, unknown to the system, like the viruses. The anti-virus, in the traditional example of the trusted computing, corresponds to the selling client. The answer “no virus exists” corresponds to the result of the computation. The user starting the anti-virus and waiting for the message “no virus exists”, in this case corresponds to the system that provides the software for the computation to the selling client and then receives the results. The virus in this case remains a virus or could be even the hardware's owner launching a software that tries to interfere with the selling client for any reason.

A further guarantee of privacy that nobody can trace the software running on the machine and the relative results can be obtained by means of software methods implemented inside the selling client. Once reliability on the selling client is guaranteed by the trusted computing, it's possible to transfer the software for the computation and safely communicate with the selling client through a protocol like the SSL (Secure Socket Layer) based on public-key cryptography.

Specifically, the wordings “data generated by computation” and “results of computation” extensively include all the possible data communicated between selling and buying clients through the system, i.e. all the communications generated during computation.

Hundreds of millions of computers are connected to Internet, but most of them are constantly “idle”, which means that their CPU is inactive for the most time. This waste of computing capacities is continuously growing, as the CPUs become more and more effective.

Especially in the desktop systems, the computer spends the most time waiting for a system action, e.g. a movement of the mouse.

This system works on one or more servers and allows the owners of the “idle” computers connected to Internet to benefit from the CPU resources at that moment unused. After the connection to the system server, through a suitable selling client, their CPU resources are put on sale as part of the WORLD WIDE SUPERCOMPUTER and can be purchased by other computers, connected to a server where this system runs, through a suitable buying client. The software system will provide great security guarantees, privacy and reliability on the software making computations and on the results supplied by the WORLD WIDE SUPERCOMPUTER. Both sellers and buyers will benefit from the software system, since the WORLD WIDE SUPERCOMPUTER will be able to offer the best price/performance ratio available on the supercomputers market and, at the same time, will offer a tangible profit to the owners of the millions of “idle” computers connected to Internet.

The enclosed flow chart describes in details how this system works.

The system is installed and works on one or more servers; once started (1), it waits for a connection (2) from any client. As one client is connected, it's revealed if it is a buyer or seller (3)

If it is an operation to sell resources (4), the system will receive the version of the selling client safely (5), by means of cryptographical modes in the hardware of the computer where the selling client runs, like the trusted computing. The system verifies the version of the selling client in order to ensure that the selling client provides the necessary reliability guarantees and in this case it proceeds; otherwise it can choose to stop the connection and disconnect the client.

After the verification of the version of the selling client, the system proceeds examining the resources made available by the seller.

At this point, it measures memory, CPU and the connection to the network (6). Having checked the hardware and verified it meets the minimal requirements, the selling client declares the best selling price. It's seller's interest to set the lowest selling price over the ceiling that allows him to make a profit considering the greater energy costs caused by the full use of his CPU during the transaction.

According to the selling price (7) and the characteristics of the hardware, the system looks for a buyer matching this selling offer (8). Once found it, the system starts the transaction. If no compatible buyers are found, the seller will stand by (9). During this waiting, the seller can cancel his offer in any moment (10), which happens even if the system finds out a disconnection by the selling client. If the operation is cancelled, the order will be invalidated (11) and the process will end (12).

On the contrary, if there is an available buyer and if the seller has not cancelled the order, the transaction will start (13).

In the case the connection is an operation to buy resources (18), the system will receive from the buying client the selection factors about the characteristics of the CPU, the RAM and the network (19), as well as a range of IP addresses (20). In order to start a transaction, these factors must comply with the ones assessed by the selling client on the sellers' computers. At this phase, the buying client specifies the price he's ready to pay for these resources. This sum, including the commissions due to the service provider, is locked in a suitable current account of the buyer, accessible to the system (21). If these hardware resources are already available in the WORLD WIDE SUPERCOMPUTER (22), the transaction will be immediately started, otherwise the buying client will stand by (23) waiting that a computer with these hardware characteristics is offered for this price.

The stand-by buyer can cancel in any moment his buying offer (24), thus the locked sum is totally released (25) without any commission expenditure. In the case the agreed sum is not available in the buyer's current account, the connection will be cancelled by the system.

If more than one buyer or seller with equivalent characteristics meet the requirements to start a computational transaction, the one that has been waiting for more time will have priority on the others.

As soon as a transaction is started (13) (at the first match of price and hardware resources offered and requested between a seller and a buyer) the buyer has no more possibilities to autonomously release the sum previously locked in his current account; even if the buyer wishes to cancel the operation after the transaction has started, the locked sum will be however transferred on the seller's account by the Software system, which will also charge the commissions.

Only if the seller disconnects or does not provide a least performance during the computation (15) (it would be possible to complete a transaction also on minimal levels of performance in next implementations of the system, but the first implementation is based on desktop systems with very high standard performance limits), the transaction will be cancelled, releasing the sum locked in the buyer's current account (16) and the process will end (12).

If the seller frequently disconnects, he will take the risk of performing partial computations without making any profit. It's therefore obvious why the system must guarantee total privacy between seller and buyer. If the buyer knows the IP address of the seller, it will be possible for him to try a “distributed denial of service attack” on the seller's IP address few minutes before the transaction is completed, after having already computed lots of data on the seller's computer. The system in this case would read the “denial service attack” as a disconnection from the selling client and would release the total sum previously locked in the buyer's account. A similar attack would damage not only the profit of the seller, but even the profit of the system.

On the other hand, if the seller knows the IP address of the buyer, it will be possible for him to try a “distributed denial of service attack” on the buyer's IP address immediately after the start of the transaction, so as to earn without working. The privacy on IP addresses provided by the system is not only important for privacy reasons, but it's also necessary to ensure the safety of the transactions of the WORLD WIDE SUPERCOMPUTER.

As soon as the transaction is started, the system allows the buyer to supply the software running on the seller's hardware and can communicate with this software to input data and receives results (14). All the communications will be made through the system and obviously, in order to make the system “scalable” (i.e. able to work efficiently even if the number of clients increases), it's necessary to allocate the system on secondary local servers in the Internet points with more users, so as to be able to reduce latency and increase the bandwidth.

The protocol of migration of the software must be defined in the implementation and is not an innovative part of this system because many methods to migrate software on remote computers are known. It's possible to provide different modes of migration of the software: some of them could work by means of decoded byte-code in order to make the WORLD WIDE SUPERCOMPUTER transparent to hardware architectures making part of it, e.g. with the use of the decoded byte-code the migration of the software on processors of different architecture would become transparent and equivalent.

Once the temporal unit of computation is completed, the system transfers the locked sum from the buyer's current account to the seller's current account and charges the commissions, also previously locked (17).

The selling client must be open source or at least having an available source, in order to allow system developers to verify that no security faults exist. A security fault in the selling client would damage the whole reliability of the WORLD WIDE SUPERCOMPUTER. Should a security fault be detected on a version of a selling client, the system will put immediately said version of the client in a blacklist and will cancel the connection of all the current and next clients of that version. If said fault client is very widespread, the resources of the WORLD WIDE SUPERCOMPUTER will be cut down in a little while, but in time clients will be updated and the computing capacity will come back to work.

An implementation error in the code of the selling client would not only be a problem for the reliability of the WORLD WIDE SUPERCOMPUTER from the buyer side (in particular, the privacy and reliability guarantees provided by the “trusted computing” could be missed), but it could also be a security problem from the seller side. For example, a buyer could make use of the error in a selling client to illicitly enter the machine where the selling client runs. Therefore, it's not only interest of the buyer, but also of the seller, that the WORLD WIDE SUPERCOMPUTER immediately rejects all the clients with version at risk.

It's highly preferable that anyone can write an open source selling client. The system developers will verify it before letting the software system accept it. In the far event that only one version of the selling client is available, the WORLD WIDE SUPERCOMPUTER will have to depend on a monoculture, so if a security problem is found in that only selling client, the resources of the WORLD WIDE SUPERCOMPUTER will be not only cut down but even cancelled in a little while. A monoculture of the selling client could entail an enormous damage. On the contrary, a polyculture of selling clients, autonomously developed, will reduce the risk of immediate cancelling of the resources of the WORLD WIDE SUPERCOMPUTER, since it's unlikely that two independent developers do exactly the same error. The system could even provide an automatic updating option of the selling client in order to speed up and simplify the updating, but a temporal gap can however occur between the detection of the error and the relative correction, during which the system must reject the connections of the fault selling client.

If a security problem occurs in the implementation of the system, all the servers where this system runs will have to be updated after the correction of the error.

The WORLD WIDE SUPERCOMPUTER is therefore always very safe against any software attack, as it can immediately react, prevent any forthcoming attack and avoid any virus instantaneously, regardless of the fact that the fault the virus uses for its insertion and reproduction is inside the system or the selling client.

The system can carry out an internal private logging of all the transactions, including personal data of users such as the IP address and the number of current account, so as to perform crossed checks on said data in order to detect all the possible criminals, if security faults are found by the users of the selling client.

The buying client in theory doesn't need any specific hardware support for cryptography and even if a security fault is detected in the buying client, the WORLD WIDE SUPERCOMPUTER will not be undermined. The whole security of the WORLD WIDE SUPERCOMPUTER is due to the implementation of the system and the selling client. It could be however preferable to insert also a safe check, supplied by a hardware cryptographical mode like the “trusted computing”, on the version of the buying client, even if it's not strictly necessary.

Understanding the development of this system, it's possible to consider that in practice few users of the selling client will have interest in assessing personally the best price on the market to sell their CPU resources. The user of the selling client wishes only to turn on and off his computer, without realizing how its CPU resources are sold while the computer is on. Hence, probably investment services will be offered also by the same company producing the system, allowing an external agent to check the selling price communicated by the selling client to the system during connection. This possibility is absolutely transparent to the working of the system that is the engine of the WORLD WIDE SUPERCOMPUTER and there is no interest to know who is the surveyor of the selling client. The only necessary issue is that the source of the selling client must be available in order to assess its security and reliability, and consequently let the system accept its connections. If the investment service has produced fewer profits than the expectations of the hardware's owner, he will take action to change investment service or invest his resources personally. Large companies with thousands of desktop machines could assign the task of trading their unused CPU resources to specialized staff. Other staff will be probably employed to check again that the selling client is safe for the seller.

In next implementations of this system, it's also possible to add the option to allow buyer and seller to freely negotiate the time of the computing slot of the transaction. It's also possible to add the opportunity to book computing slots in future, so as to allow the buyer to previously collect the resources of computation, possibly at a more convenient price that the one possible to get in the moment he needs them. This last possibility should also reduce the volatility of the CPU market, making it more efficient. Said future reserved slots could be also sold again. These and further minor additions to the system would be however details of implementation that could be added in the forthcoming versions of the same system. The basic function making the system work is described in the flow chart and remains still unchanged, as it can be only integrated with further details in time. The advantages of these details are not easy to foresee, they will be therefore object of specific research when the system will be already in production.

It's possible to let test clients and production clients coexist in the same WORLD WIDE SUPERCOMPUTER, so as to be able to make additional upgrades to the WORLD WIDE SUPERCOMPUTER. Obviously, production clients will not be able to open a computing transaction with test clients, if test clients require new functions not yet supported by production clients.

In time, the market that can be reached with obsolete clients would become disadvantageous, inviting clients to an upgrade. The software system could also force an upgrade in any moment, rejecting connections from very obsolete clients, in order to reduce the number of client versions to support and therefore also the complexity of the system.

As the selling client could be driven not personally by the hardware's owner, also the buying client could be driven by an automatic software, so as to be able to launch, for example, an application distributed by a shell, assigning the task to buy the remote resources to a software that will check and interact with the buying client. Also in this case there is no limit of implementation and interaction of the buying client with external agents.

Other servers, called “Browsing servers”, will be strictly connected to the server where the software system runs. Browsing servers will provide a browsing service in order to control the state of the WORLD WIDE SUPERCOMPUTER. Said service will permit to find the best selling and buying offers according to all the possible various factors supported by the system and by selling and buying clients. The whole information about the state of the WORLD WIDE SUPERCOMPUTER will be public and supplied by said browsing servers in real-time, in order to make this market as efficient as possible. The browsing client is the means used by sellers and buyers to receive this information from the browsing servers in order to assess the state of the market and decide the best price they can offer for their buying or selling orders.

The details of the protocols used to connect and communicate with the servers where the system runs and with the browsing servers must be published, in order to permit the free development of the software of the selling, buying and browsing clients.

FIG. 2 highlights how buyers and sellers are connected by means of the servers where the system runs. The drawing shows two local servers (26, 27) allowing buyers (28) and sellers (29) to communicate without any need to always pass through the central server (30) where the software system runs. The communications of the software for computations, as well as of the data and the results, only pass through the local servers, while the negotiations for the selling and buying price and therefore all the transactions are totally carried out through the central server, to be able to read the buying and selling offers generated through other local servers. There can be also more levels of local servers. The amount of the traffic of network generated by the negotiations to start the transaction is very low compared with the traffic of network generated by the transfer of the software for computations and by the communication of the data and results. Local servers significantly increase the progressive feature of the system and so permit to control much more clients in a more effective way than a single central server where the system runs could do. The system runs only on “local system servers” and on the “central system server”. The software running on buyers' and sellers' computers is respectively the buying and selling client; said two software clients are in no way covered by this patent, so as to allow final users (both buyers and sellers) to develop and improve without any restriction the software running on their own computers, and in order to ensure the maximum interaction with all the current and next operating systems on the market. Installing numerous local servers (26, 27) will be very expensive, therefore, in the first implementation of this system, it may happen to be compelled for a lack of liquidity to choose a simplified test mode of the system, where the privacy and security guarantees against the “distributed denial of service attacks” are invalidated, letting the selling and buying client directly communicate (therefore also showing their IP address) without necessarily communicate the whole software and data by means of the local servers. This way, the band necessary to the local servers is reduced, so that each local server can control a greater number of simultaneous transactions. A second possible solution to reduce the initial costs for the installation of the local servers, however maintaining the privacy and security guarantees of the system, is to use computers offered by “partners” and employ them as local servers (26, 27) by means of the technique of the “trusted computing”, as it is already used to make the selling client reliable. These hypothetical rent local servers should be located in large band zones on the Internet and should be not hided from firewall, so as to be able to receive the connections from the selling and buying clients. Obviously, the owner of these computers would be compensated with a part of the commissions. They would be therefore like rent local servers and the “trusted computing” would also ensure their reliability, as it already occurs for the selling client. At the moment, we cannot foresee if these solutions would ever be necessary, because it depends on financial factors currently not possible to estimate. However, the second technique is only a detail of implementation of this system and it wouldn't undermine its working (it's therefore preferable even if more complex to implement).

Other financial details of implementation, which at the moment cannot be foreseen, include the amount of the commissions, the modes of taxation, of conversion of currency and of control of the current account. In order to increase the liquidity and decrease the volatility of the CPU market, it's also possible to reward the users waiting with a limit order and penalize the ones who effectively trigger the transaction immediately without waiting, raising the amount of the commissions of a definite sum (herein called penalty), in the case the buyers start the transactions immediately without waiting for a limit order. Said penalty (contrary to the other commissions that are always cashed by the system) would then be transferred with the rest of the agreed sum from the current account of the buyer to the one of the seller waiting for a limit order. At the moment, it's not possible to foresee if the use of this penalty will be preferable.

Considering the characteristics of this market, in the most cases the buyer will start the transaction, thus someone could think this system should have been designed in a simpler way, i.e. forcing the buyer to buy when starting a transaction and forcing the seller to always wait before the start of the transaction with a limit order. This is true: the system would have worked in the same way, but allowing both the seller and the buyer to start the transactions and wait with a limit order seems to make the market more effective. For example, if the seller has no possibility to immediately sell starting a transaction, the price of the CPU will increase faster. The same kind of inefficiency will occur if the buyers have no possibility to wait with a limit order.

### BRIEF DESCRIPTION OF DRAWINGS

FIG. 1 shows the flow chart of this system.

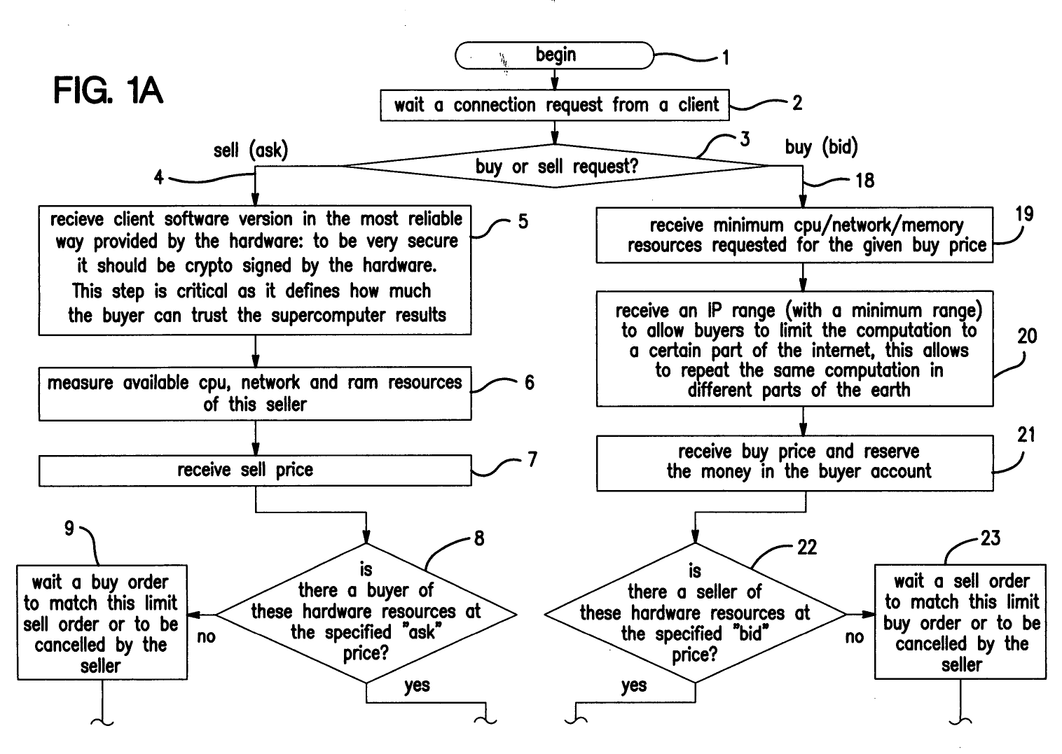

FIG. 2 shows a block diagram of the hardware system.

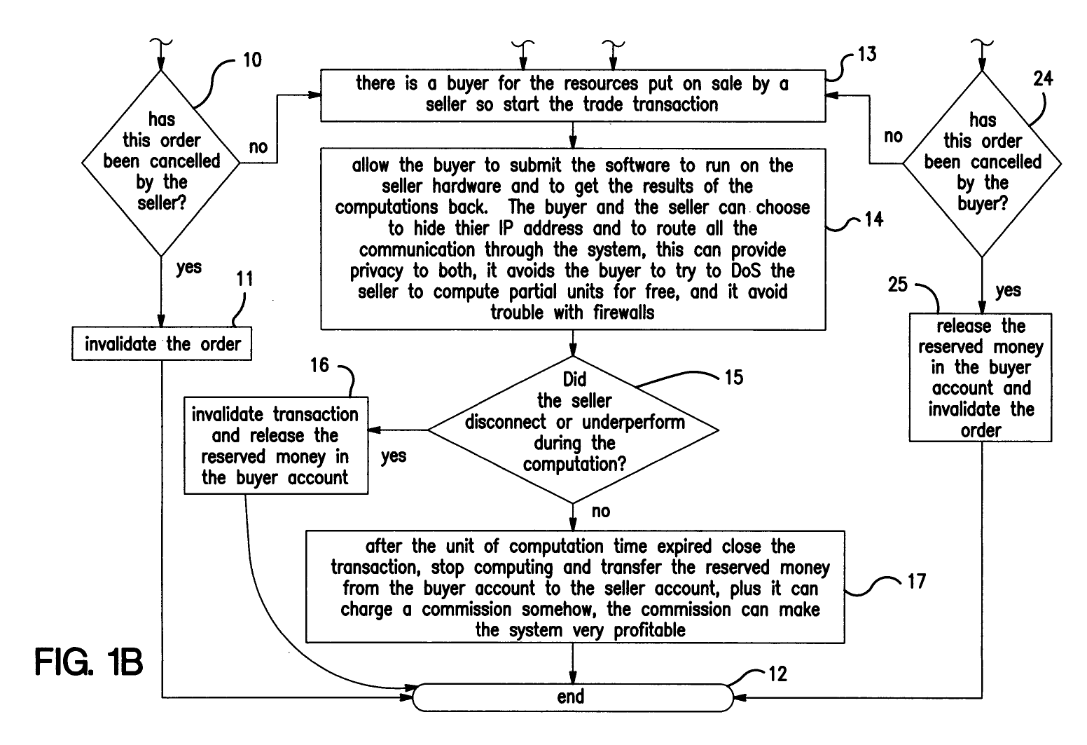

1) System for the creation of a supercomputer characterized in that possible sellers are connected with possible buyers of CPUs of computers, so that a purchasing price and an amount of CPU can be offered and accepted to meet the requirements of the parties performing the operation; the purchase and sale are completed automatically by the system, with the relative transfer of the CPU and of the memory of the computer from the seller to the buyer, as well as the transfer of the sum paid by the buyer to the seller, ensuring security, quickness and privacy during the transaction;

2) System according to claim 1, characterized in that computers are connected each other by means of the Internet network.

3) Method for the creation of a supercomputer, characterized in that it comprises the following stages:
a) If it is an operation to sell resources (4):
The system will receive the version of the selling client safely (5), by means of cryptographical modes in the hardware of the computer where the selling client runs; it verifies the version of the selling client in order to ensure that the selling client provides the necessary reliability guarantees and in this case it proceeds.
The system measures memory, CPU and the connection to the network (6).
The system receives the selling price (7) and the characteristics of the hardware, then looks for a buyer matching this selling offer (8).
If the buyer is found, the system will start the transaction; otherwise the seller will stand by (9), having still the possibility to cancel his offer in any moment (10).
If the operation is cancelled, as in the previous point or in the case of a disconnection by the selling client, the order will be invalidated (11) and the process will end (12), vice versa the transaction will start (13).
b) If it is an operation to buy resources (18):
The system will receive from the buying client the selection factors about the characteristics of the CPU, the RAM and the network (19), as well as a range of IP addresses (20).
The buying client specifies the price he's ready to pay for these resources.
This sum, including the commissions due to the service provider, is locked in a suitable current account of the buyer, accessible to the system (21).
If these hardware resources are already available in the WORLD WIDE SUPERCOMPUTER (22), the transaction will be immediately started, otherwise the buying client will stand by (23) waiting that a computer with these hardware characteristics is offered for this price; the stand-by buyer can cancel in any moment his buying offer (24), thus the locked sum is totally released (25); in the case the agreed sum is not available in the buyer's current account, the connection will be cancelled by the system.
c) As soon as a transaction is started (13), the buyer has no more possibilities to autonomously release the sum previously locked in his current account; even if the buyer wishes to cancel the operation after the transaction has started, the locked sum will be however transferred on the seller's account by the system; only if the seller disconnects or does not provide a least performance during the computation (15), the transaction will be cancelled, releasing the sum locked in the buyer's current account (16) and the process will end (12).
d) As soon as the transaction is started, the system allows the buyer to supply the software running on the seller's hardware and can communicate with this software to input data and receives results (14).
e) Once the temporal unit of computation is completed, the system transfers the locked sum from the buyer's current account to the seller's current account and charges the commissions, also previously locked (17).

4) System for the creation of a supercomputer characterized in that it comprises a central computer (server), where the program to perform the method according to claim 3 is installed, connected with buyers' and sellers' computers, which communicate with the central server (30) by means of local servers (26, 27), so that the communications of the software for computations, as well as of the data and the results, only pass through the local servers, while the negotiations for the selling and buying price and all the transactions are carried out through the central server, to be able to read the buying and selling offers generated through other local servers.

5) Program for computer characterized in that it comprises a code able to perform all the stages of the method according to claim 3, when said program runs on a computer.

6) Program for computer according to claim 5, characterized in that it is integrated in a support that can be read by a computer.
